(19) United States
(12) Patent Application Publication
(10) Pub. No.: US 2017/0026621 A1
(43) Pub. Date: Jan. 26, 2017

(54) SYSTEM AND METHOD FOR COMMUNICATIONS

(71) Applicant: Orvito, Inc., Waltham, MA (US)

(72) Inventors: Mohan Vellanki, Banjara Hills (IN); Varma SVRP, Banjara Hills (IN); Aditya Musunuru, Banjara Hills (IN)

(21) Appl. No.: 14/808,372

(22) Filed: Jul. 24, 2015

(51) Int. Cl. H04N 7/18; H04N 7/14

(52) U.S. Cl. CPC H04N 7/186; H04N 7/148

(57) ABSTRACT

A wireless door phone includes a wireless interface for users' registered wireless devices and a visitor interface including microphone, speaker, and imaging devices for providing full duplex audio and one-way video communications between a visitor and user.

### TECHNICAL FIELD

Inventive concepts generally relate to entrance security systems, and, in particular, to a video entrance security system.

### BACKGROUND

Entrance security systems have evolved from a push-button simplex (that is, one-talker-at-a-time) voice system to systems that permit a user to visually monitor an entrance, while, at the same time, carrying on a simplex voice interaction with a visitor.

### SUMMARY

Example embodiments in accordance with principles of inventive concepts include an electronic device that is configured to provide full duplex voice communications and one-way video communications (monitoring) for a user's specified location, such as at an entrance to an individual housing unit (an apartment, for example) or an individual commercial unit (an office or store within an office or retail building, for example).

Example embodiments in accordance with principles of inventive concepts include a door phone that includes a wireless interface for communication with a user; a bidirectional voice interface for communication with a visitor; an imaging device for imaging a visitor area; and a controller configured to examine a message received through the wireless interface to ensure that the message has originated from a wireless device that has been registered with the door phone.

Example embodiments in accordance with principles of inventive concepts include a door phone that includes a controller that is configured to detect an authentication token to ensure the message has originated from a wireless device that has been registered with the door phone.

Example embodiments in accordance with principles of inventive concepts include a door phone that includes a controller configured to respond to an input from a visitor interface by alerting a wireless device registered with the door phone of the input from a visitor.

Example embodiments in accordance with principles of inventive concepts include a door phone that includes a controller configured to respond to an input from a user through the wireless interface by establishing a full duplex voice channel.

Example embodiments in accordance with principles of inventive concepts include a door phone that includes a controller configured to respond to an input from a user to establish video monitoring of a visitor area.

Example embodiments in accordance with principles of inventive concepts include a door phone that includes an imaging device that includes an infrared imager.

Example embodiments in accordance with principles of inventive concepts include a door phone that includes a controller configured to capture and store images from the imaging device.

Example embodiments in accordance with principles of inventive concepts include a door phone that includes an illumination device.

Example embodiments in accordance with principles of inventive concepts include a security system that includes a wireless door phone including a wireless user interface and full duplex audio visitor interface; and a cloud server, wherein the cloud server maintains a database of wireless door phones and wireless devices respectively registered with the wireless door phones.

Example embodiments in accordance with principles of inventive concepts include a security system that includes a wireless door phone that includes a wireless interface for communication with a user; a bidirectional voice interface for communication with a visitor; an imaging device for imaging a visitor area; a controller configured to examine a message received through the wireless interface to ensure that the message has originated from a wireless device that has been registered with the door phone.

Example embodiments in accordance with principles of inventive concepts include a security system wherein the imaging device comprises a low-light-level imager.

Example embodiments in accordance with principles of inventive concepts include a security system wherein the controller is configured to detect an authentication token to ensure the message has originated from a wireless device that has been registered with the door phone.

Example embodiments in accordance with principles of inventive concepts include a security system that includes a controller configured to be responsive to commands received from a registered wireless device to adjust the imager.

Example embodiments in accordance with principles of inventive concepts include a security system that includes a controller responsive to activation of a visitor input by alerting a group of wireless devices registered to the door phone to said activation.

Example embodiments in accordance with principles of inventive concepts include a security system that includes a door phone connected to a wireless local network and is configured to respond to activation of a visitor input by broadcasting to all registered wireless devices connected to the same local wireless network a visitor alert, the wireless devices that receive the broadcast alert provide an indication to users, and, if no user response is received through the wireless network, the controller prompts the visitor to generate a video voicemail message.

Example embodiments in accordance with principles of inventive concepts include a security system that includes a door phone is connected to a local wireless network, is configured to broadcast to all registered wireless devices in the same local wireless network in response to visitor activation of an input, and to forward the visitor input to the cloud server if there is no response from a wireless device in the same local wireless network, and the cloud server is configured to initiate connection to all wireless devices that are registered with the door phone that are not in the same wireless local network as the door phone.

Example embodiments in accordance with principles of inventive concepts include a security system that includes a first wireless door phone configured to respond to visitor activation input by connecting to a cloud server, the cloud server connecting to a second wireless door phone, and the other wireless door phone establishing a voice over internet protocol communications link between the wireless door phone and a wireless device registered with the second door phone.

Example embodiments in accordance with principles of inventive concepts include a security system that includes a cloud server that correlates door phones with their respective locations within a multi-unit complex, a door phone connects to a cloud server in response to visitor activation of an input related to a location within the multi-unit complex, the cloud server passes the visitor activation information to the wireless door phone correlated with the visitor activation location; and the door phone correlated with the location broadcasts an activation alert to all wireless devices registered with the wireless door phone.

Example embodiments in accordance with principles of inventive concepts include a security system that includes an infrared illumination device responsive to commands from a wireless device registered with the door phone.

Example embodiments in accordance with principles of inventive concepts include a security system that includes an imager that is responsive to commands from a wireless device registered with the door phone to store video of a visitor area.

### BRIEF DESCRIPTION OF THE DRAWINGS

The foregoing and other objects, features and advantages of embodiments of inventive concepts will be apparent from the description of example embodiments, as illustrated in the accompanying drawings in which like reference characters refer to the same elements throughout the different views. The drawings are not necessarily to scale, emphasis instead being placed upon illustrating the principles of the preferred embodiments.

FIG. 1 is a block diagram of an exemplary embodiment of a security system in accordance with principles of inventive concepts;

FIG. 2 is a block diagram of an exemplary embodiment of a wireless door phone in accordance with principles of inventive concepts;

FIG. 3 is a block diagram of an exemplary embodiment of a security system including multiple users monitoring a visitor;

FIG. 4 is a flow chart illustrating execution of a call in a security system in accordance with principles of inventive concepts; and

FIG. 5 is a block diagram of an exemplary embodiment of a cloud server in accordance with principles of inventive concepts.

### DETAILED DESCRIPTION

Various exemplary embodiments will be described more fully hereinafter with reference to the accompanying drawings, in which exemplary embodiments are shown. The inventive concepts may, however, be embodied in many different forms and should not be construed as limited to exemplary embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, and/or devices, these elements, components, and/or devices should not be limited by these terms. These terms are only used to distinguish one element, component, or device from another. In this manner, a first element, component, or device discussed below could be termed a second element, component, or device without departing from the teachings of inventive concepts.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural farms as well, unless the context clearly indicates otherwise. It will be further understood that the terms “comprises” and/or “comprising,” when used in this specification, specify the presence of stated features, integers, steps, operations, elements, and/or components, as examples, but do not preclude the presence or addition of one or more other features, integers, steps, operations, elements, components, and/or groups thereof.

Exemplary embodiments are described herein with reference to illustrations that are schematic illustrations of idealized exemplary embodiments (and intermediate structures). As such, variations from the shapes of the illustrations are to be expected. In this manner, exemplary embodiments should not be construed as limited to the particular shapes illustrated herein, but are to include deviations in shapes.

Processes may be described as including steps that proceed in a certain order, but inventive concepts are not limited thereto, unless indicated. Other sequences of steps, substitution or deletion of steps, or other processes are contemplated within the scope of inventive concepts.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Wireless devices may include cellular telephones, tablet computers, smartphones, and laptop computers, for example. Such wireless devices may adhere to a wireless standard, such as IEEE 802.11, for example. For clarity and conciseness, exemplary embodiments may employ a smartphone as an example of wireless device. However, it will be understood that inventive concepts are not limited to a smartphone implementation. Similarly, wireless networks are not limited to those complying with IEEE 802.11, but, for clarity and conciseness of description, networks will generally be referred to herein, simply, as wireless networks.

In exemplary embodiments, in a system in accordance with principles of inventive concepts a wireless video door phone may operate in conjunction with a private cloud and smartphone application (that is, any wireless device with the application) to provide remote access to an access point through video and voice communication channels. The video door phone may provide two-way voice and one-way video communications, allowing a user to carry on a conversation with a visitor at an access point while visually monitoring the visitor and surroundings. The access point may be outside an individual unit within a housing or commercial complex, may be at the entrance to one building within a compound of buildings, may be at an entrance to an entire complex, at a gate, for example, or may be at the entrance to a standalone structure. A camera included in the wireless video door phone may allow a user to remotely control the field of view by panning, zooming, or otherwise targeting the field of view. The video door phone may include, or operate in conjunction with, illuminators, or lights, such as visible-spectrum or infrared spectrum illuminators and/or low light level sensors, including photomultipliers, to allow a user to view the access point in low light level viewing situations, as well as in daylight viewing. The smartphone application may include a user interface that provides control of the video door phone functions, with commands transferred to, and data received from the video door phone through a network established by a wireless router. The wireless video door phone and smartphone may also be in communication with a private cloud through the wireless router. In a control mode of operation (which may correspond with a Wi-Fi “Infrastructure” mode), a wireless video door phone in accordance with principles of inventive concepts may receive a command from a smartphone application through a wireless router and respond by authenticating the source, interpreting the command, and responding to a command, once the source has been authenticated, to establish two-way voice communication, to establish video monitoring, or to adjust a camera or illumination device, for example.

In exemplary embodiments in accordance with principles of inventive concepts, a wireless video door phone includes both infrared (IR) and visual light sensors, a two-way voice channel, and a wireless interface, such as one conforming to the IEEE 802.11 standard, for communicating with a smartphone. Although the term Wi-Fi may be used herein for clarity and conciseness of explanation, any wireless communications protocol may be employed by a wireless video door phone in accordance with principles of inventive concepts.

The wireless video door phone may be responsive to commands received through the wireless link, accepting commands that arrive from an authenticated smartphone to, for example, establish bidirectional voice communication, increase or decrease volume settings, mute, or to turn on and adjust a camera. The video door phone may authenticate the source of the command using a token included in the command from the smartphone. The wireless video door phone then responds to the command received from the smartphone to adjust and/or establish links as previously described. The smartphone may be configured to accept updates pushed from the cloud. The wireless video door phone may monitor commands it receives and upload a history of the commands to a dedicated cloud for analysis, for example.

A smartphone (again, although we use the term “smartphone” for exemplary purposes, this could be any wireless device, such as a cellular telephone, a tablet computer, a notebook computer, or a desktop computer, for example) may include an application that provides a user interface for control of functions provided by the video door phone. A user may employ the smartphone to transmit commands to the video door phone, with the smartphone providing a user interface that accepts commands and voice input and displays video information. A token system may be employed by a wireless video door phone in accordance with principles of inventive concepts to ensure that any commands it executes are received from authorized, registered, smartphones. A token system such as may be employed by a wireless video door phone and associated wireless devices is described in co-pending US application entitled, “SYSTEMS AND METHODS FOR CONTROLLING ELECTRICAL DEVICES, filed on Jul. 24, 2014, and having application Ser. No. 14/340,092, which is hereby incorporated by reference.

The cloud may include a server with a database of video door phone registration information and user information associated with authentication information. Registration information may correlate users, user groups, individual wireless video door phone devices, and a multi-tiered organization of wireless video door phones, associated groups, building units, buildings, and complexes and processes that allow users to complete calls and monitor access points remotely and to place voice over internet protocol VOIP calls among registered smartphones.

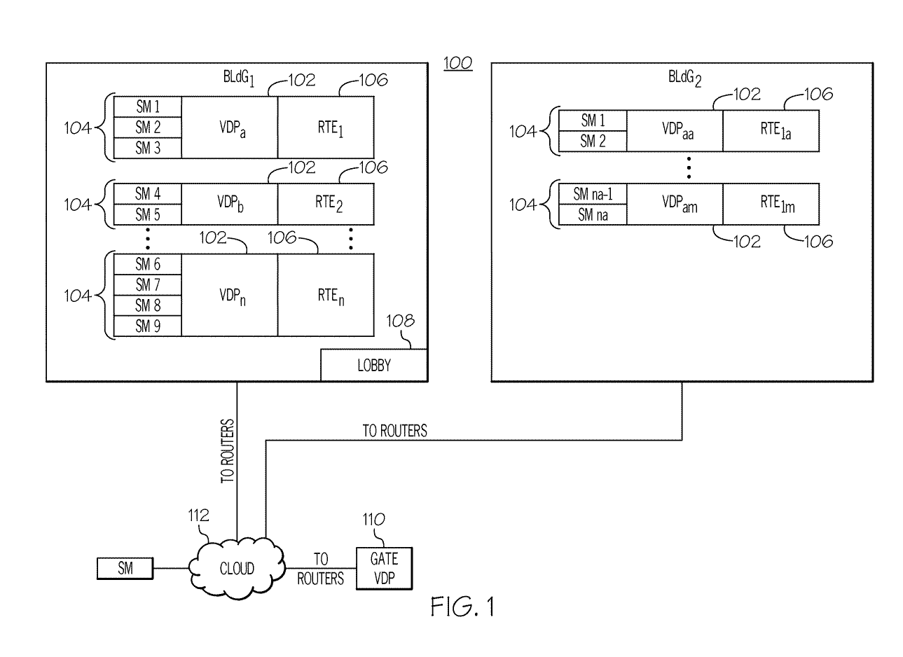

The block diagram of FIG. 1 illustrates an exemplary embodiment of a video door phone system 100 in accordance with principles of inventive concepts. In this exemplary embodiment a plurality of wireless video door phones 102 in accordance with principles of inventive concepts are associated, one each, with individual units 103 in a building complex 101. Wireless video door phones VDa-VDn are associated, respectively, with units APTa-APTn, wireless video door phones VDaa-VDnn are associated, respectively, with units APTaa-APTnn, etc. Additional wireless video door phones may be located in a building lobby 108 or at a gate or other access point to a building complex 110. A wireless video door phone 102 in accordance with principles of inventive concepts may operate in a hierarchical system, such as illustrated in the buildings of FIG. 1, or may operate in a standalone manner, with a system such as that of unit APTa implemented in a single family dwelling or lone commercial unit, for example.

As will be described in greater detail below, a wireless video door phone in accordance with principles of inventive concepts may be accessed by a group of users employing smartphone applications 104 each of which is registered with the wireless video door phone 102 and cloud 112, which includes a processor and storage for maintenance of a wireless video door phone database, for example. Each video door phone 102, may communicate with smartphones in a group 104 through a wireless link, through a router 106, for example.

Smartphones that are in an associated wireless video door phone's communication group, that have registered with the video door phone and cloud, that is, may access the wireless video door phone 102 while at a different location, for example, than the unit with which the video door phone is physically associated. That is, a user located down the block, across town, in another city, state, or country than is the video door phone may access the video door phone 102 through a link to the cloud 112 and, from there, to a router 106 and wireless video door phone 102, for example. Such communication may be initiated on either end—the video door phone may initiate contact, in response to a visitor's input, or a user may initiate contact by contacting the video door phone to, for example, visually monitor the area within view of the video door phones camera. Additionally, a user can initiate a call to a group, and all smartphones in the group will ring, with answering scenarios described in greater detail below.

Just as individual groups, such as family groups, may have access to a video door phone associated with a single unit 103, a “group of groups,” for example, all groups within a building 107 may permit access to a wireless video door phone located in a building's lobby, for example. Such access may be controlled, for example, through a user interface on the video door phone that provides a directory of users within the building and allows a visitor to attempt to contact any of the users within the building. On the other hand, any and all users within the building could simultaneously monitor the video interface provided by the video door phone located in the lobby 108. At another level of the hierarchy, a video door phone in accordance with principles of inventive concepts located at a gate to the complex that includes the buildings, may similarly provide access to group members within the buildings and monitoring access for video and audio monitoring to all in the building. As previously indicated, although this exemplary embodiment illustrates a system with a plurality of video door phones, smartphones, and wireless routers, a system in accordance with principles of inventive concepts may be implemented with a single video door phone, a wireless router, and a smartphone loaded with a wireless video door phone application in a standalone scenario.

Wireless router 108 also provides access to private cloud 110. Private cloud 110 may include a database that includes a user directory, for example. In some circumstances a smartphone 106 may communicate directly with wireless video door phone 102 in accordance with principles of inventive concepts. For example, when implemented as a Wi-Fi compatible network and operating in an “ad hoc” mode, smartphone 106 may communicate directly with wireless video door phone 102 for registration or other housekeeping functions. During regular operations, while simply executing control operations for example, smartphones 106 may communicate with wireless video door phone 102 through a network established by router 108, employing “Infrastructure” mode when implemented as a Wi-Fi compatible network. Wireless video door phone 102 may include a button that allows a user to toggle the device between ad hoc and infrastructure modes, for example.

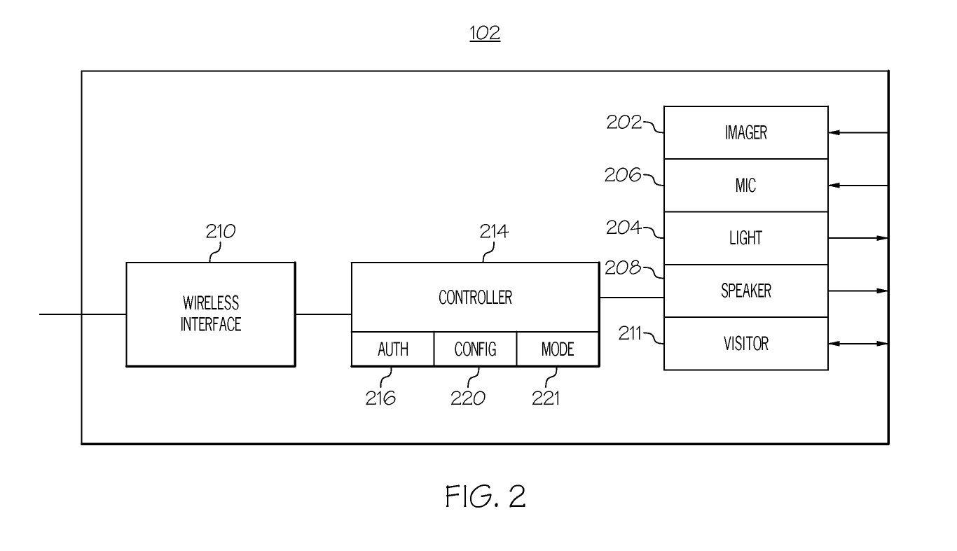

The functional block diagram of FIG. 2 is of an exemplary embodiment of a wireless video door phone 102 in accordance with principles of inventive concepts. In this exemplary embodiment wireless video door phone 102 includes a wireless interface 210, one or more imagers 202, including video imagers that operate in visible and infrared spectra, one or more light sources 204, including infrared and/or visible light sources, a microphone 206, a speaker 208, and a visitor interface 211, which may include tactile (touchscreen or keypad, for example), voice, or other input means and a display that, for example, may be used to display a directory of users within a building, for example. Controller 214 is responsive to the wireless interface and visitor interface and provides registration, call logging, and other functions. Wireless interface 210 is configured to provide a wireless link (an IEEE 802.11 interface, for example) to wireless devices such as cellular telephones, tablets, etc., generally referred to herein as a smartphone.

Controller 214 may be implemented in dedicated hardware using, for example, an application specific integrated circuit, or may be implemented using a microprocessor or microcontroller combined with firmware or software, for example. Controller 214 may include an identification and verification functional block that verifies that a smartphone attempting to access the video door phone's functions, such as video monitoring or the bidirectional audio link, has registered with the network associated with the video door phone, and that an authenticated security token has been received from the smartphone. Controller 214 may also respond to input from the visitor interface 211 by alerting smartphones to the presence of a visitor and establishing communications between the visitor and smartphone user, as described in greater detail below.

Controller 214 may include an authentication block 216. The authentication block 216 may ensure that an authentication token has been received, as will be described in greater detail below. Configuration block 220 operates when the wireless video door phone 102 is in an ad hoc mode to configure network settings, including passwords, and service set identifier (SSID), as will be described in greater detail below.

A user may employ an application on smartphone such as PH1, accessing controller 214 directly, rather than through router 108, to provide the configuration block 220 with the necessary configuration information. Mode selection interface 221 may include a button located on the wireless video door phone 214 and may, when activated, toggle the mode of the wireless video door phone 102 between ad hoc and infrastructure modes of operation, for example. The password stored in configuration block 220 may be employed by controller 214 when operating in the infrastructure mode, along with a service set identifier (SSID) to connect to a network through router 108. Wireless video door phone 102 may be registered with the cloud 110 using a smartphone application as described in greater detail below.

In operation a wireless video door phone 102 may search for and join an existing network using a stored password and SSID. Once the wireless video door phone 102 has joined a network, it may send a probe message to all devices on the network it has joined. Any device compatible with the wireless remote controller 102 that is connected to the network responds to alert the wireless video door phone 102 to their presence on the network. When a smartphone, using an application in accordance with principles of inventive concepts, responds to the probe message it creates a registration between the remote controller and the application on the phone.

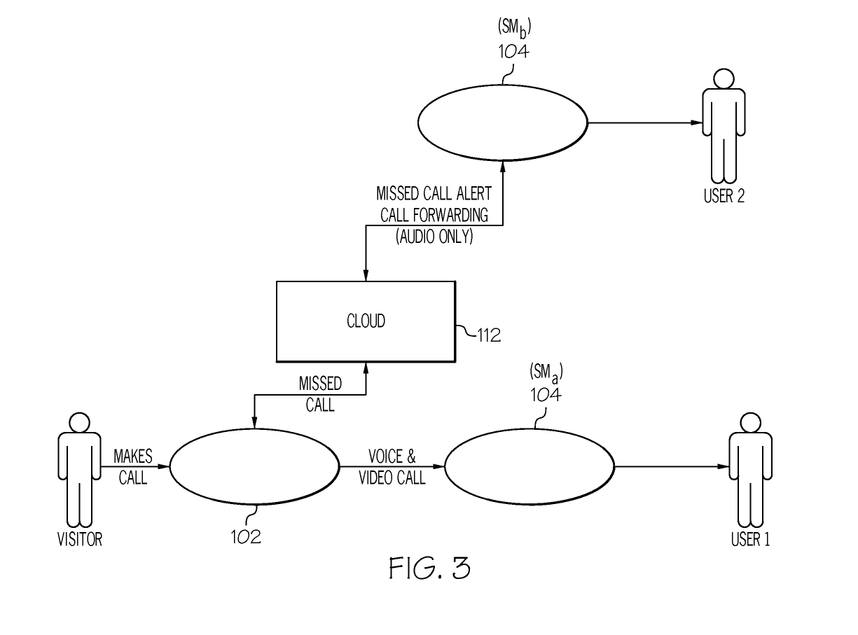

As illustrated in FIG. 3, wireless video door phone 102 may connect directly with a smartphone 104 using a wireless signal, and the smartphone user may configure their personal wireless network details into wireless video door phone. In operation, video door phone 102 queries all active smartphone applications in the network, each of which is required to connect with wireless video door phone 102. Wireless video door phone 102 also connects via the Internet to private cloud 112 for remote calling. Because the wireless video door phone 102 provides wireless communications to users through their smartphones 104 (SMa and SMb in this embodiment) wireless video door phone installation is relatively easy, connections are flexible, throughout the immediate range of a wireless router used in conjunction with the video door phone, and remote connections, allowing bidirectional voice and video monitoring are supported. A user interface allows a user to establish an ongoing “call” with a visitor, with full duplex communications, rather than a half-duplex communication path as is common with an intercom (where button activations are required for user and visitor to hand off the communication channel, back and forth, for example). In exemplary embodiments in accordance with principles of inventive concepts, wireless video door phone 102 automatically records and stores images of visitors, for future use, in security applications, for example.

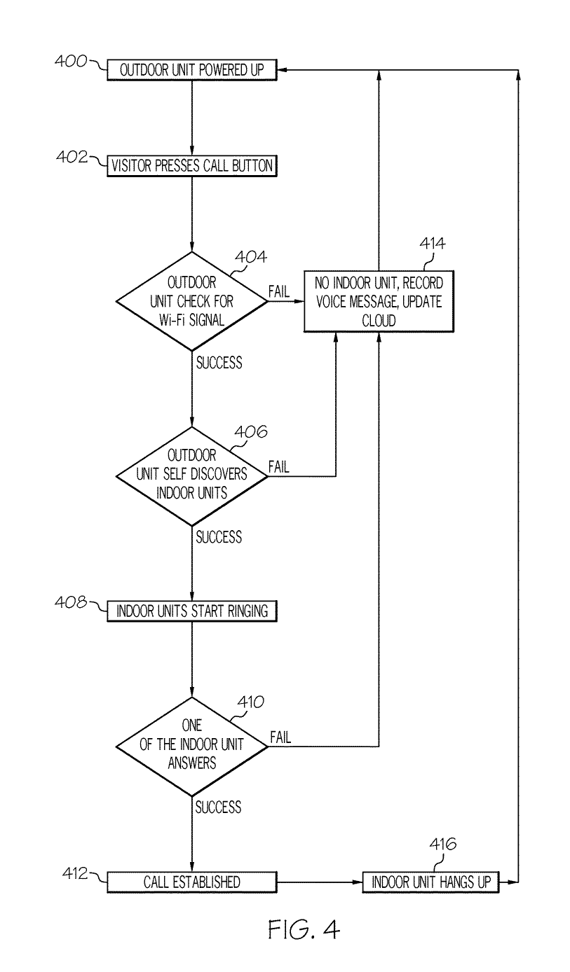

The flow chart of FIG. 4 may be used to illustrate call execution in accordance with principles of inventive concepts. A wireless video door phone, also referred to herein as an outdoor unit is powered up in step 400 and initialized. In exemplary embodiments, a wireless video door phone in accordance with principles of inventive concepts may alert/ring all smartphones in a group associated with it when a visitor activates the device (by depressing a “call” button on the video door phone, for example), in step 402. A wireless video door phone in accordance with principles of inventive concepts may be responsive to commands from a wireless device to, for example, activate a relay in a door lock to lock or unlock a door associated with the wireless video door phone. A user may, for example, transmit an “unlock” command using the wireless device's user interface to the wireless video door phone and the wireless video door phone may activate a relay that, in turn, operates a magnetic door lock to unlock the door. In the event the wireless video phone detects no wireless connection (step 404), fails to discover associated smartphones, also referred to herein as indoor units, (step 406) or no one answers a visitor call (step 410) after ringing discovered smartphones (step 408), the video door phone may send an alert to all users in associated group, regardless of their location, that a visitor was missed. Calls may also be automatically forwarded by the video door phone, and voice mail may be stored on the device.

In exemplary embodiments, a wireless video door phone 102 connects over home wireless network and waits for inputs from visitor, in the form of activating a button (step 402), which may be a physical button, or a button icon, on a display of the video door phone, for example. When a visitor activates the button, the video door phone sends simultaneous incoming call request notifications to all smartphone applications registered and connected with the video door phone. That is, the notification is sent to all smartphones that are both registered with the video smartphone and have been detected by the video door phone in response to its query. All smartphones connected to the video door phone start to “ring” simultaneously (step 408). The first smartphone application user to respond to the incoming call request gets to establish a two-way audio and one way video call between the wireless video door phone and the answering smartphone application.

If there is no response from any application in the group accepting the call, the video smartphone tries to connect to the private cloud to find any remote (apps which are away from the home) apps which are ready to accept the call. If no remote applications are available either, the video door phone requests that the visitor leave a video voice mail (step 414). Such requests may be stored in the video door phone as pre-recorded audio files and various indicators, which may be visual indicators, may be used to alert a visitor as to the status of a call, and to guide him through the process of recording a video voice mail. Such indicators may include: ready to call; not ready to make a call; ringing; in call, no response; start recording; recording of voicemail stopped; and night vision enabled for camera.

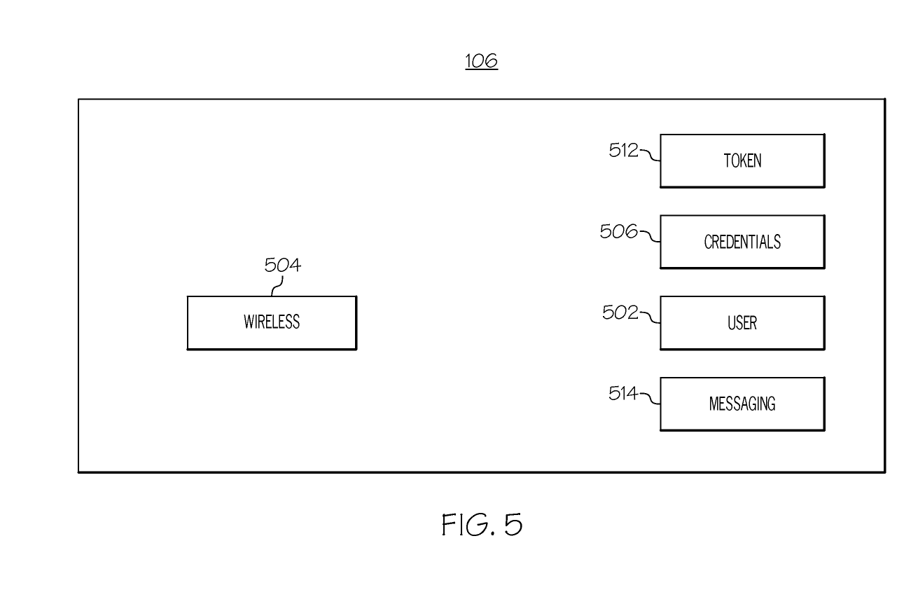

In exemplary embodiments of FIG. 5 a smartphone 106 loaded with an application in accordance with principles of inventive concepts may include: a user interface 502, a wireless interface 504, credentials 506, an authentication token 512, and social media messages 514. Smartphone 106 may include an application that operates as the user interface for control of wireless video door phone 102. The smartphone application, the user interface, in particular, may be employed by a user to register the wireless video door phone 102 with cloud 110. In exemplary embodiments, the smartphone app requires the user to create a new user name and password and provide a unique serial number of the wireless video door phone 102 associated with the smartphone 106. The application connects with the cloud 110 and requests “validation” and “activation” of the wireless video door phone 102 by the cloud. The cloud validates the serial number as a valid device using a database of valid wireless video door phone 102 serial numbers. When validated, the cloud 110 generates an authentication token, which, in exemplary embodiments, may be a 32 byte unique alpha-numeric string. The authentication token is returned to the smartphone application and is also stored on the cloud and registered as the token for the wireless video door phone 102 having the specified serial number. The smartphone application, on first time configuration of the wireless video door phone 102, sends the authentication token to the wireless video door phone 102. The wireless video door phone stores the token and employs it for all future validation.

Any newly introduced smartphone logs in with the cloud, providing credentials, that include a username, a password (which can different from apps on other smartphones using the same wireless video door phone 102), and the serial number of the wireless video door phone 102. The cloud, in response, will give the smartphone's application the authentication token, already registered for the wireless video door phone 102. The application associated with the second (or subsequent) smartphone uses this same authentication token for communication with the wireless video door phone 102. A plurality of different users with different usernames can connect with the same wireless video door phone 102 by employing the serial number of the wireless video door phone 102 during registration and obtaining the authentication token. In this manner, a system and method in accordance with principles of inventive concepts may accommodate multiple users on a single wireless video door phone 102. A group, such as a family with a number of users, each with a different smartphone, username, and password, could operate the same wireless video door phone 102 to control a number of appliances in the same area.

In exemplary embodiments in accordance with principles of inventive concepts, a smartphone application may be downloaded from an online store, for example. The user may then, as previously described, register a new username and password with the cloud. User details such as email, mobile phone number, region zip code and television service provider may also be provided at this time. The smartphone application's user interface captures this information and saves it in the cloud data 110, in the user's file 308. After the user downloads the smartphone application and uses it to register, the cloud will wait for the smartphone application to register a wireless video door phone 102, using the unique serial number associated with the wireless video door phone 102. After registering the wireless video door phone 102, the smartphone that employed the app to register the wireless video door phone 102 will be linked to that device's serial number, using a network identifier, such as a media access control (MAC) address (in an IEE 802.11 exemplary embodiment), of the smartphone, which the smartphone app uploads to the cloud 110. The smartphone application is given the authentication token of the wireless video door phone 102 for communication with the wireless video door phone 102.

After successful registration of the application with the cloud, the user can log into the application using the user credentials (that is, user name and password) and the application will cache the credentials on the smartphone. If there is no internet link to the cloud, the application will use the cached credentials to login in the user interface and take the user to the dashboard of wireless video door phone 102.

In exemplary embodiments in accordance with principles of inventive concepts a user may download a video door phone application to their smartphone 104 and register, first, their smartphone, then their wireless video door phone 102, using the smartphone application to provide registration information. The smartphone application may guide a user through the smartphone registration, helping to establish a link with the private could through a wireless router, then prompting the user to enter his email address and the serial number of the smartphone (IMEI/MAC address, for example) to the private cloud. The private cloud maintains a registration database, which may include, for example, registration information regarding wireless video door phones and associated smartphones, and email addresses of associated users. After registering a smartphone with the cloud, the user may then register a wireless video door phone, using the smartphone application. The user may enter the serial number of the wireless video door phone using the smartphone application, the user interface of which may provide a scanning function, allowing the user to scan the serial number of the wireless video door phone. The user's smartphone registration information (for example, email address and IMEI/MAC address, or the user's telephone number, which may be correlated with the IMEI/MAC address) may be accepted by the smartphone application, and the application linked to the private cloud. The application then registers the wireless video door phone with the private cloud, using the wireless video door phone's serial number, user email, and telephone number. Subsequent users, others within the group served by the wireless video door phone, may register their smartphones using a similar process, allowing the cloud and wireless video door phone to recognize the new smartphone as an approved device within the group.

In exemplary embodiments a wireless video door phone in accordance with principles of inventive concepts may include an administrative function whereby, in a multi-unit facility, with wireless video door phones installed an administrative function may create a virtual group of users, linked through the private cloud. Users within a group may communicate with one another through the cloud, using the video door application on their respective smartphones.

In exemplary embodiments, a wireless video door phone in accordance with principles of inventive concepts, which is always connected to a local wireless network through router 106, may respond to a visitor's activation of a call button by broadcasting a call alert message to all smartphones registered in the group and signed into the wireless network. All those smartphones ring, simultaneously and, when a user answers the call, a voice over internet protocol session initiation protocol (VOIP SIP) call is established between the answering smartphone and the wireless video door phone. Once a smartphone answers, ringing stops in other smartphones in the group. The call that is established provides one-way video (observing the visitor) and full duplex audio communications.

In exemplary embodiments in accordance with principles of inventive concepts, if no registered smartphone connected to the local wireless network answers the call, the call may be forwarded to registered smartphones. If call-forwarding has not been enabled, the wireless video door phone may prompt the visitor to leave a message, as previously described. On the other hand, if call forwarding has been enabled, the wireless video door phone may connect with the private cloud through the local wireless network, with which it is already connected. The private cloud maintains the current state of all smartphones registered to the wireless video door phone and will initiate an incoming call request to all of those devices that are connected to the Internet. Whichever smartphone responds first to the incoming call request will be connected by the cloud to the wireless video door phone with a VOIP SIP call, which may support only fully duplex audio communications, for example. If, again, no one answers the call within a prescribed period, the wireless video door phone may prompt the visitor to leave a message.

In exemplary embodiments, a multi-tier system including a wireless video door phone in accordance with principles of inventive concepts, may allow a wireless video door phone, which may be configured to operate as a gate 110 or lobby 108 visitor monitor/reception device, may accept a visitor's input of an apartment or unit number (selected from a listing of units, for example), in response to which, the wireless video door phone may connect to the cloud, where the relationships of all wireless video door phones and associated smartphones in the complex/community (all within a group of buildings served by a reception device at a gate to the complex, for example) are maintained in a database. The cloud responds by contacting the wireless video door phone associated with the apartment number supplied by the visitor and the selected wireless video door phone proceeds to complete or forward the call, or request a voicemail message, as previously described.

In exemplary embodiments in accordance with principles of inventive concepts a smartphone user interface may display all other users/smartphones registered with the same wireless video door phone (in the same group, that is) and allow any of the users to place a VOIP call to any other user in the group. For a local network call, the call is initiated by a user of the wireless video door phone, which connects to the cloud and, from there, to the smartphone of the targeted user. For a call placed to a user within the group, but who is at a different location than that of the wireless video door phone with which his smartphone is registered, the caller initiates the call, the wireless video door phone connects to the cloud, and the cloud places the call through a wireless router through which the second user is connected to the Internet.

In exemplary embodiments in accordance with principles of inventive concepts, a smartphone user interface may display all other users/smartphones, or unit identities (apartment numbers, for example) registered with a wireless video door phone within the same building or complex of buildings and allow any of the users to place a VOIP call to any other user in that combination of wireless video door phone groups. For a local network call, the call is initiated by a user of the wireless video door phone, which connects to the cloud and, from there, to the wireless video door phone associated with the targeted apartment. This second wireless video door phone then proceeds to broadcast the call to smartphones connected to its network and the call proceeds from there as previously described. If there is no answer from a smartphone within the targeted group, the second wireless video door phone returns a message, through the cloud, indicating to the caller that there is no answer.

While the present inventive concepts have been particularly shown and described above with reference to exemplary embodiments thereof, it will be understood by those of ordinary skill in the art, that various changes in form and detail can be made without departing from the spirit and scope of the present inventive concepts described and defined by the following claims.

What is claimed is:

1. A door phone, comprising:
a wireless interface for communication with a user;
a bidirectional voice interface for communication with a visitor;
an imaging device for imaging a visitor area; and
a controller configured to examine a message received through the wireless interface to ensure that the message has originated from a wireless device that has been registered with the door phone.

2. The door phone of claim 1, wherein the controller is configured to detect an authentication token to ensure the message has originated from a wireless device that has been registered with the door phone.

3. The door phone of claim 1, wherein the controller is configured to respond to an input from a visitor interface by alerting a wireless device registered with the door phone of the input from a visitor.

4. The door phone of claim 1, wherein the controller is configured to respond to an input from a user through the wireless interface by establishing a full duplex voice channel.

5. The door phone of claim 1, wherein the controller is configured to respond to an input from a user to establish video monitoring of a visitor area.

6. The door phone of claim 1, wherein the imaging device includes an infrared imager.

7. The door phone of claim 1, wherein the controller is configured to capture and store images from the imaging device.

8. The door phone of claim 1, further comprising an illumination device.

9. A security system, comprising:
a wireless door phone including a wireless user interface and full duplex audio visitor interface; and
a cloud server, wherein the cloud server maintains a database of wireless door phones and wireless devices respectively registered with the wireless door phones.

10. The security system of claim 9, wherein the wireless door phone comprises:
a wireless interface for communication with a user;
a bidirectional voice interface for communication with a visitor;
an imaging device for imaging a visitor area;
a controller configured to examine a message received through the wireless interface to ensure that the message has originated from a wireless device that has been registered with the door phone.

11. The security system of claim 10, wherein the imaging device comprises a low-light-level imager.

12. The security system of claim 10, wherein the controller is configured to detect an authentication token to ensure the message has originated from a wireless device that has been registered with the door phone.

13. The security system of claim 12, wherein the controller is configured to be responsive to commands received from a registered wireless device to adjust the imager.

14. The security system of claim 10, wherein the controller is responsive to activation of a visitor input by alerting a group of wireless devices registered to the door phone to said activation.

15. The security system of claim 14, wherein the door phone is connected to a wireless local network and is configured to respond to activation of a visitor input by broadcasting to all registered wireless devices connected to the same local wireless network a visitor alert, the wireless devices that receive the broadcast alert provide an indication to users, and, if no user response is received through the wireless network, the controller prompts the visitor to generate a video voicemail message.

16. The security system of claim 14, wherein the door phone is connected to a local wireless network, is configured to broadcast to all registered wireless devices in the same local wireless network in response to visitor activation of an input, and to forward the visitor input to the cloud server if there is no response from a wireless device in the same local wireless network, and the cloud server is configured to initiate connection to all wireless devices that are registered with the door phone that are not in the same wireless local network as the door phone.

17. The security system of claim 14, wherein a first wireless door phone is configured to respond to visitor activation input by connecting to a cloud server, the cloud server connecting to a second wireless door phone, and the other wireless door phone establishing a voice over internet protocol communications link between the wireless door phone and a wireless device registered with the second door phone.

18. The security system of claim 17, wherein the cloud server correlates door phones with their respective locations within a multi-unit complex, a door phone connects to a cloud server in response to visitor activation of an input related to a location within the multi-unit complex, the cloud server passes the visitor activation information to the wireless door phone correlated with the visitor activation location; and the door phone correlated with the location broadcasts an activation alert to all wireless devices registered with the wireless door phone.

19. The security system of claim 10, further comprising an infrared illumination device responsive to commands from a wireless device registered with the door phone.

20. The security system of claim 10, wherein the imager is responsive to commands from a wireless device registered with the door phone to store video of a visitor area.
